(19) United States
(12) Patent Application Publication
(10) Pub. No.: US 2016/0202519 A1
(43) Pub. Date: Jul. 14, 2016

(54) LIQUID CRYSTAL DISPLAY HAVING IMPROVED LATERAL VISIBILITY

(71) Applicant: Samsung Display Co., Ltd., Yongin-City (KR)

(72) Inventors: Ji Phyo HONG, Pyeongtaek-si (KR); Dan Bi YANG, Gunpo-si (KR); Min-Joo HAN, Seoul (KR); Ki Chul SHIN, Seongnam-si (KR); Jae Hoon JUNG, Anyang-si (KR)

(21) Appl. No.: 14/811,653

(22) Filed: Jul. 28, 2015

(30) Foreign Application Priority Data
Jan. 9, 2015 (KR) 10-2015-0003673

(51) Int. Cl. G02F 1/1343; G02F 1/1333

(52) U.S. Cl. CPC G02F 1/1343; G02F 1/133345; G02F 2001/133394

(57) ABSTRACT

A liquid crystal display according to an exemplary embodiment of the present invention includes: a first insulation substrate; a thin film transistor disposed on the first insulation substrate; a pixel electrode connected to the thin film transistor; a second insulation substrate facing and spaced apart from the first insulation substrate; a common electrode disposed on the second insulation substrate; a liquid crystal layer disposed between the pixel electrode and the common electrode; and one or more piezoelectric elements overlying one or more portions of at least one of the pixel electrode and the common electrode.

### CROSS-REFERENCE TO RELATED APPLICATION

This application claims priority to, and the benefit of, Korean Patent Application No. 10-2015-0003673 filed in the Korean Intellectual Property Office on Jan. 9, 2015, the entire contents of which are incorporated herein by reference.

### BACKGROUND

(a) Field

Embodiments of the present invention relate generally to liquid crystal displays. More specifically, embodiments of the present invention relate to liquid crystal displays having improved lateral visibility.

(b) Description of the Related Art

Flat panel displays have found wide acceptance as visual display devices. The flat panel display can be implemented as a liquid crystal display, an organic light emitting display, a plasma display, an electrophoretic display, an electrowetting display, or the like.

Generally, a liquid crystal display device includes a lower panel. The lower panel includes a gate electrode which is an extension of a gate wire, a semiconductor layer which forms a channel, a source electrode which is an extension of a data wire, and a drain electrode. A thin film transistor is a switching element which transfers or blocks an image signal received through the data wire to a pixel electrode according to a scanning signal received through the gate wire.

Some liquid crystal displays have a vertically aligned mode, in which major axes of liquid crystal molecules are aligned to be perpendicular to a panel when no electric field is applied. The vertically aligned mode has been preferred in some cases for its relatively large contrast ratio and wide reference viewing angle. In this case, the reference viewing angle refers to those viewing angles with a contrast ratio of 1:10 or a luminance inversion limit angle between grays.

There has been proposed a method for changing transmittance by dividing one pixel into two subpixels and applying different voltages to the two subpixels in the liquid crystal display in order to improve lateral visibility to the point that it is close to frontal visibility.

However, this approach suffers from the problem that transmittance is reduced due to a decrease in an aperture ratio when one pixel is divided into two subpixels.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a liquid crystal display in which one pixel includes one thin film transistor and includes a plurality of divided regions having different electric fields.

An exemplary embodiment of the present invention provides a liquid crystal display, including: a first insulation substrate; a thin film transistor disposed on the first insulation substrate; a pixel electrode connected to the thin film transistor; a second insulation substrate facing and spaced apart from the first insulation substrate; a common electrode disposed on the second insulation substrate; a liquid crystal layer disposed between the pixel electrode and the common electrode; and one or more piezoelectric elements overlying one or more portions of at least one of the pixel electrode and the common electrode.

The piezoelectric elements may be transparent.

The piezoelectric elements may be made of any one or more of polydimethylsiloxane (PDMS), nanowire graphene, and polyvinylidene difluoride (PVDF).

The pixel electrode includes a plurality of plates and connection parts connecting adjacent plates.

Edges of the plates define a plurality of regions, and the piezoelectric elements of different ones of the regions are not connected to each other.

The piezoelectric elements may be disposed in one or more of the regions.

The plurality of regions may include a first region, a second region, and a third region. The piezoelectric elements may be disposed on the common electrode in the first region and may be disposed on the pixel electrode in the third region.

The piezoelectric elements in different regions may have differing thicknesses.

The piezoelectric elements may be disposed on the common electrode.

The liquid crystal display may further include a floating electrode disposed on the common electrode.

The piezoelectric elements may be disposed on the floating electrode.

The liquid crystal display may further include an insulating layer disposed under the piezoelectric elements, and the insulating layer may have different thicknesses in different regions.

According to the above-described display device, it is possible to provide a pixel which is divided into a plurality of regions even though the pixel has only one thin film transistor receiving one voltage, thereby improving lateral visibility and transmittance.

### BRIEF DESCRIPTION OF THE DRAWINGS

FIG. 1 is a plan view of one pixel according to an exemplary embodiment of the present invention.

FIG. 2 is a cross-sectional view taken along line II-II″ of FIG. 1.

FIG. 3 is a cross-sectional view taken along line III-III of FIG. 1.

FIGS. 4 to 6 are cross-sectional views taken along line III-III of FIG. 1 according to another exemplary embodiment of the present invention.

FIG. 7 is a V-T graph of one pixel according to an exemplary embodiment of the present invention.

FIG. 8 is a gamma graph of one pixel according to an exemplary embodiment of the present invention.

FIGS. 9 and 10 are V-T graphs according to a positive polarity and a negative polarity applied to a display constructed according to exemplary embodiments.

### DETAILED DESCRIPTION OF THE EMBODIMENTS

Exemplary embodiments of the present invention will be described in detail with reference to the accompanying drawing. However, the present invention may be modified in various different ways, all without departing from the spirit or scope of the present invention. Rather, the described exemplary embodiments are provided so that the disclosed contents will be thorough and complete and will fully convey the inventive concept to a person of an ordinary skill in the art.

In the drawings, the thicknesses of some layers and areas are exaggerated for convenience of explanation. The Figures are thus not to scale. In addition, it will be understood that when a layer is referred to as being “on” another layer or substrate, it can be directly on the other layer or substrate or a third layer may be disposed therebetween. Like reference numerals designate like constituent elements throughout the specification. All numerical values are approximate, and may vary.

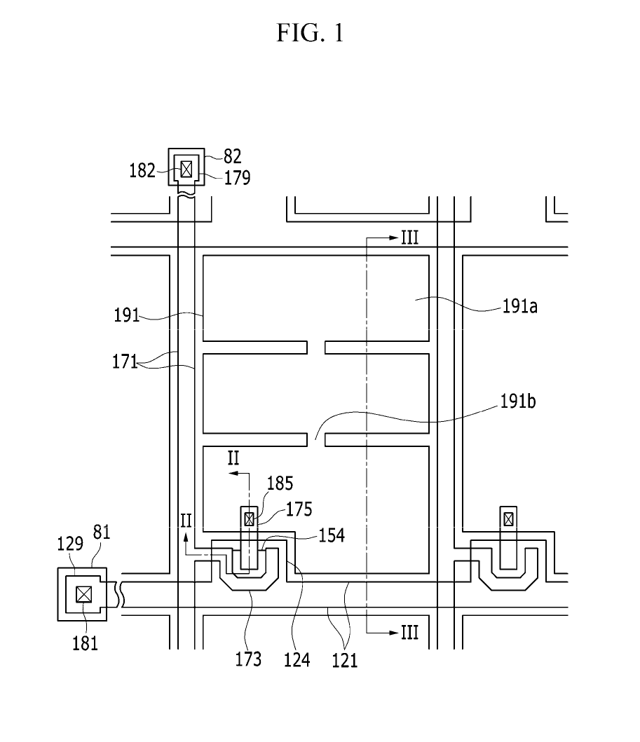

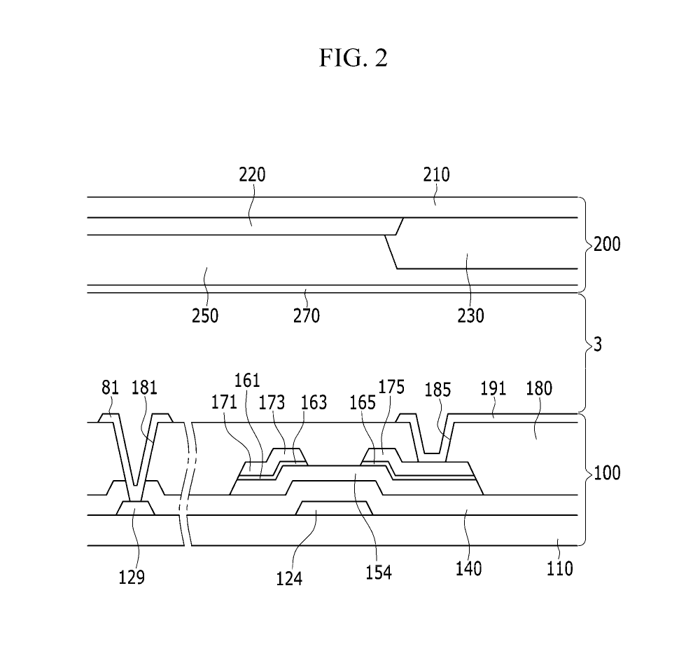

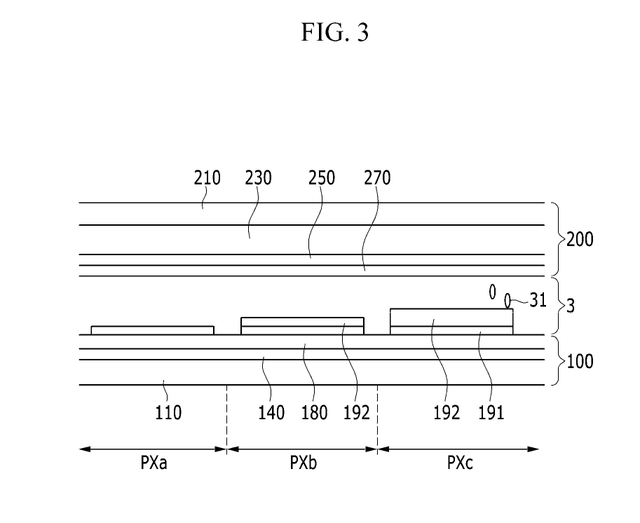

Hereinafter, a liquid crystal display according to an exemplary embodiment of the present invention will be described in detail with reference to FIGS. 1 to 3. FIG. 1 is a plan view of one pixel according to an exemplary embodiment of the present invention, FIG. 2 is a cross-sectional view taken along line II-II″ of FIG. 1, and FIG. 3 is a cross-sectional view taken along line III-III of FIG. 1.

First, referring to FIGS. 1 and 2, a display device according to an exemplary embodiment of the present invention includes a lower panel 100, an upper panel 200, and a liquid crystal layer 3 disposed between the two panels 100 and 200.

First, the lower panel 100 will be described.

A plurality of gate wires extending in a first direction and a plurality of data wires extending in a second direction intersecting the first direction are disposed on a first insulation substrate 110 which is made of transparent glass or plastic, or the like. Multiple pixel parts are each defined by the gate wires and the data wires in the first insulation substrate 100.

Each of the gate wires 121 transfers a gate signal and substantially extends in a horizontal direction, in the view of FIG. 1. Each of the gate wires 121 includes a gate pad 129 which is a wide end portion for connection to a plurality of gate electrodes 124 protruding from the gate wire 121, and to another layer or a gate driver (not shown).

The gate electrodes 124 may be formed from the same metal pattern as the gate wires. Although the gate electrodes 124 are illustrated as being a single layer in the exemplary embodiment of the present invention, the gate electrodes may have a dual (or more) layer structure.

As an example, when the gate electrode 124 is a dual layer electrode, the gate electrode 124 may have a structure in which a lower metal layer made of any one selected from aluminum (Al) and aluminum neodymium (AlNd) and an upper metal layer made of molybdenum (Mo) are sequentially stacked. The lower metal layer is a layer which functions as a conductor for an electric signal which is a basic function of wires, and is made of aluminum (Al) and aluminum neodymium (AlNd) which have a low specific resistance. The upper metal layer functions to protect the lower metal layer, to prevent formation of aluminum (AL) hillocks occurring in a post high-temperature process, and to reduce a contact resistance between the pixel electrode and the lower metal layer.

A gate insulating layer 140 is made of an insulation material such as silicon nitride, and is disposed on the gate wires 121.

A semiconductor layer 154 made of amorphous silicon, in particular hydrogenated amorphous silicon or polysilicon, is disposed on the gate insulating layer 140. According to an exemplary embodiment of the present invention, the semiconductor layer 154 may be a semiconductor layer 154 including hydrogenated amorphous silicon (a-si:H).

The semiconductor layer 154 substantially extends in a vertical direction under the drain electrode 175, and also projects toward and over the gate electrode 124.

A plurality of ohmic contact stripes and islands 161 and 165 are disposed on the projections of the semiconductor layer 154. The ohmic contact stripes 161 includes a plurality of projections 163 and the projections 163 and the ohmic contact islands 165 are respectively paired and are disposed on the projections of the semiconductor layer 154.

The plurality of data wires 171, a plurality of source electrodes 173 connected to the plurality of data wires 171, and a plurality of drain electrodes 175 facing the source electrodes 173 are disposed on the ohmic contacts 161 and 165 and the gate insulating layer 140.

The data wires 171 transfer a data signal, substantially extend in a vertical direction (in the view of FIG. 1), and intersect the gate wires 121. The source electrode 173 may extend toward the gate electrode 124 and have a U-shape. However, this is just an example, and the source electrode 173 may have variously-profiled shapes. Any shape is contemplated.

The drain electrode 175 is separate from the data wire 171 and extends upward from the center of the U-shaped source electrode 173. The data wires 171 include a data pad 179 having an area for connection to another layer or a gate driver (not shown).

Although not shown, any one or more of the data wires 171, the source electrode 173, and the drain electrode 175 may also have a dual-layer structure with an upper layer and a lower layer. The upper layer may be made of copper (CU) or copper alloy, and the lower layer may be made of one of titanium (Ti), tantalum (Ta), molybdenum (Mo), and/or any alloy thereof. Any number of layers, each made of any material(s), is contemplated.

Any one or more of the data wires 171, the source electrode 173, and the drain electrode 175 may each also have a tapered side.

The ohmic contacts 161, 163 and 165 exist only between the semiconductor layer 154 and the respective overlying data wires 171 and drain electrodes 175, and reduce a contact resistance therebetween. Also, the ohmic contacts 161, 163 and 165 may have a planar pattern substantially identical to that of the respective data wire 171, the source electrode 173, and the drain electrode 175.

The projection of the semiconductor layer 154 has an exposed portion disposed between the source electrode 173 and the drain electrode 175, which is not covered by the data wire 171 and the drain electrode 175. The semiconductor layer 154 has a planar pattern substantially identical to that of the ohmic contacts 161 and 165, except for the exposed portion.

One gate electrode 124, one source electrode 173, and one drain electrode 175 collectively make up a single thin film transistor (TFT) along with the projection 154 of the semiconductor layer 151. A channel of the thin film transistor is formed in the projection 154 between the source electrode 173 and the drain electrode 175.

A passivation layer 180 is disposed on the drain electrode 175 and the exposed portion of the semiconductor layer 154. The passivation layer 180 is made of, for example, an inorganic insulator such as silicon nitride or silicon oxide, an organic insulator, or a low dielectric insulator.

A contact hole 181 exposing the gate pad 129 is disposed in the passivation layer 180 and the gate insulating layer 140. Also, a contact hole 182 exposing the data pad 179 of the data wire 171 and a contact hole 185 exposing one end of the drain electrode 175 are each disposed in the passivation layer 180.

A pixel electrode 191 and contact assistants 81 and 82 are disposed on the passivation layer 180 and in the respective contact holes 185, 181, and 182. The pixel electrode 191 and contact assistants 81 and 82 may be made of a transparent conductive material such as ITO or IZO, or a reflective metal such as aluminum, silver, chromium, or any alloy thereof.

The pixel electrode 191 is physically and electrically connected to the drain electrode 175 through the contact hole 185 and receives a data voltage from the drain electrode 175.

The contact assistants 81 and 82 are respectively connected to an end portion 129 of the gate wire 121 and an end portion 179 of the data wire 171 through the contact holes 181 and 182. The contact assistants 81 and 82 supplement adhesion between the gate pad 129 of the gate wire 121 and the data pad 179 of the data wire 171, and external devices, and also protect the gate pad 129 and data pad 179.

The pixel electrode 191 according to an exemplary embodiment of the present invention includes a plurality of plate parts 191a and connection parts 191b which connect adjacent plate parts 191a. The plate parts 191a are platelike structures that can each be referred to as an individual plate.

In this embodiment, one pixel includes one pixel electrode 191 and one thin film transistor, and includes a plurality of regions which are separated by the plate parts 191a. As an example, the pixel electrode 191 according to an exemplary embodiment of the present invention includes three plate parts 191a and two connection parts 191b which connect the three plate parts 191a, and includes a first region PXa, a second region PXb and a third region PXc which are each generally defined by one of the plate parts 191a.

Although the pixel electrode 191 is described as including the three plate parts 191a and the three regions containing the three plate parts 191a, it will be apparent to one of ordinary skill in the art that the present invention is not limited thereto and a pixel electrode 191 having two plate parts or three or more plate parts may instead be used.

A piezoelectric element 192 may be disposed on the pixel electrode 191, and in particular may be disposed on any one or more of the plate parts 191a as shown in FIG. 3. The piezoelectric element 192 may have the same plan view shape as its corresponding plate part 191a.

The piezoelectric element 192 is affected by the electric field formed by application of a voltage to the pixel electrode 191, causing mechanical displacement due to the effect of the electric field. Therefore, when a voltage is applied, a cell gap in a region in which the piezoelectric element 192 is disposed becomes different from that in a region in which the piezoelectric element 192 is not disposed. The region in which the piezoelectric element 192 is disposed and the region in which the piezoelectric element 192 is not disposed may be separated from each other depending on a dielectric constant of the piezoelectric element 192. That is, the piezoelectric element 192 acts to increase the cell gap when a voltage is applied to its corresponding pixel electrode 191. Thus, in the regions containing the piezoelectric element 192, a capacitance which affects liquid crystal molecules may be reduced, and therefore, the pre-tilt angle of the liquid crystal molecules in regions containing piezoelectric elements 192 becomes different from that in regions not containing a piezoelectric element 192. That is, different luminances are created.

The piezoelectric element 192 may be disposed on one or more regions corresponding to the plate parts 191a. The piezoelectric elements 192 disposed in the respective regions may be separated from each other and have an independent form. In particular, different piezoelectric elements 192 are not connected to each other.

As an example, the piezoelectric element 192 may be disposed to overlay the pixel electrode 191 in the second region PXb and the third region PXc, but not in the first region PXa. That is, the piezoelectric element 192 may be present in regions PXb and PXc, but not in region PXa. Also, the piezoelectric elements 192 respectively disposed in the second region PXb and the third region PXc may have different thicknesses. Embodiments of the invention contemplate piezoelectric elements 192 formed to overlie any partial area or portion of pixel electrode 191, at any variable thickness.

When the thicknesses of the piezoelectric elements 192 are different from each other, cell gaps between the upper panel 200 and the lower panel 100 in the regions become different from each other, thereby providing regions having different luminances.

The piezoelectric element 192 may be made of any material as long as the material is transparent and converts electric energy into mechanical displacement. As an example, the material may be one of polydimethylsiloxane (PDMS), nanowire graphene, and polyvinylidene difluoride (PVDF).

Next, the upper panel 200 will be described with reference to FIG. 2.

A light blocking member 220 is disposed on a second insulating substrate 210 which may be made of, for example, transparent glass or plastic. The light blocking member 220 blocks light leakage between the pixel electrodes 191 and defines an opening region facing the pixel electrode 191.

A plurality of color filters 230 is disposed on the second insulating substrate 210 and the light blocking member 220. Most of the color filters 230 are each disposed within a respective region surrounded by the light blocking member 220. The color filter 230 may extend corresponding to the row of pixel electrodes 191. Each of the color filters 230 may display one primary color, such as one of the colors red, green, and blue.

Although the light blocking member 220 and the color filters 230 are described as being disposed in the upper panel 200 in the present exemplary embodiment, one of ordinary skill in the art will realize that at least one of the light blocking member 220 and the color filters 230 may instead be disposed in the lower panel 100.

An overcoat 250 is disposed on the color filters 230 and the light blocking member 220. The overcoat 250 may be made of, for example, (organic) insulating material. The overcoat 250 prevents exposure of the color filters 230 and provides a flat surface. The overcoat 250 may be omitted.

A common electrode 270 is disposed on the overcoat 250. The common electrode 270 is made of a transparent conductor, such as ITO or IZO, and receives a common voltage Vcom.

A liquid crystal layer 3 disposed between the lower panel 100 and the upper panel 200 includes liquid crystal molecules having negative dielectric anisotropy. The liquid crystal molecules may be aligned such that main axes thereof are perpendicular to the inner surfaces of the two panels 100 and 200 in a state in which there is no electric field.

The pixel electrode 191 and the common electrode 270 together form a liquid crystal capacitor along with the liquid crystal layer 3 therebetween, so that an applied voltage is maintained even after a thin film transistor has been turned off.

The pixel electrode 191 overlies a storage electrode line (not shown) and forms a storage capacitor, thereby enhancing a voltage storage capability of the liquid crystal capacitor.

According to an exemplary embodiment of the present invention, one pixel includes one thin film transistor and one pixel electrode. Even when the same voltage is applied through piezoelectric elements disposed in respective regions, it is possible to provide a plurality of regions having different luminances, thereby providing a display device having improved lateral visibility.

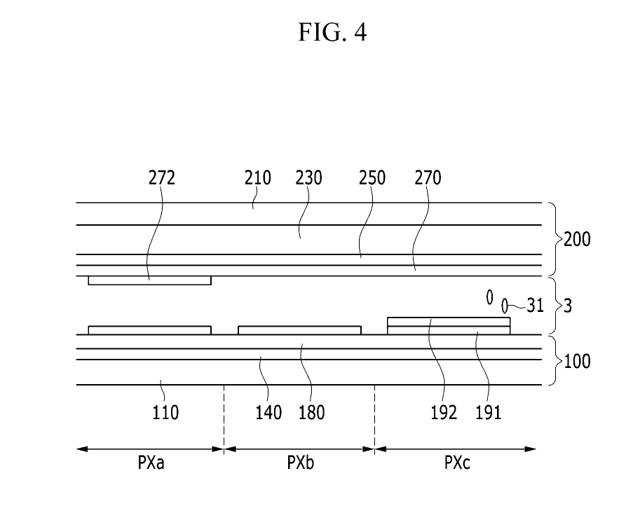

Hereinafter, a liquid crystal display according to another exemplary embodiment of the present invention will be described with reference to FIGS. 4 to 6. FIGS. 4 to 6 are cross-sectional views taken along line III-III of FIG. 1 according to another exemplary embodiment of the present invention. A description of elements similar to or the same as those of the above-described exemplary embodiment of the present invention will be omitted below.

First, referring to FIG. 4, a pixel electrode 191 according to an exemplary embodiment of the present invention includes a plurality of plate parts 191a and connection parts 191b which connect adjacent plate parts 191a as shown in FIG. 1.

One pixel includes one pixel electrode 191 and one thin film transistor, and includes a plurality of regions which are defined by individual plate parts 191a. As an example, the pixel electrode 191 according to an exemplary embodiment of the present invention includes three plate parts 191a and two connection parts 191b which each connect adjacent plate parts 191a, and includes a first region PXa, a second region PXb and a third region PXc each containing one of the plate parts 191a.

The piezoelectric elements 192 and 272 may be disposed on the pixel electrode 191 or the common electrode 270. According to another exemplary embodiment of the present invention, as shown in FIG. 4, the piezoelectric element 272 is disposed on the common electrode 270 in the first region PXa and the piezoelectric element 192 is disposed on the plate part 191a in the third region PXc.

Therefore, since different electric fields are formed in the first region PXa in which the piezoelectric element 272 is disposed on the common electrode 270, the second region PXb in which there is disposed no piezoelectric element, and the third region PXc in which the piezoelectric element 192 is disposed on the pixel electrode 191, one pixel provides three different regions each potentially having a different configuration of piezoelectric elements.

On the other hand, when the display device is driven by inversion driving, similar electric fields having different polarities may be generated in the first region PXa and in the third region PXc. Therefore, luminance deviation does not occur even in inversion driving.

According to another exemplary embodiment of the present invention, an area of the piezoelectric element 192 disposed on the pixel electrode 191 may be identical to an area of the piezoelectric element 272 disposed on the common electrode 270. That is, piezoelectric elements disposed in different panels may be symmetrically formed, i.e. have substantially the same shape and size, thereby reducing luminance deviation due to inversion driving.

The piezoelectric elements 192 and 272 are affected by an electric field formed due to application of a voltage to the pixel electrode 191, so that the piezoelectric elements 192 and 272 increase in height according to application of the electric field. Therefore, when a voltage is applied, a cell gap in regions in which the piezoelectric elements 192 or 272 are disposed becomes different from that in a region in which the piezoelectric elements 192 and 272 are not disposed. The regions in which the piezoelectric elements 192 and 272 are disposed and the regions in which the piezoelectric elements 192 and 272 are not disposed may be separated from each other according to a dielectric constant of the piezoelectric element 192. In the regions containing a piezoelectric element 192 or 272, a capacitance which affects liquid crystal molecules may be reduced, and therefore, pre-tilt angle of the liquid crystal molecules in regions containing piezoelectric elements becomes different from that in region not containing piezoelectric elements. That is, different luminances are generated.

The piezoelectric element 192 may be made of any material as long as the material is transparent and converts electric energy into mechanical displacement. As an example, the material may be one of polydimethylsiloxane (PDMS), nanowire graphene, and polyvinylidene difluoride (PVDF).

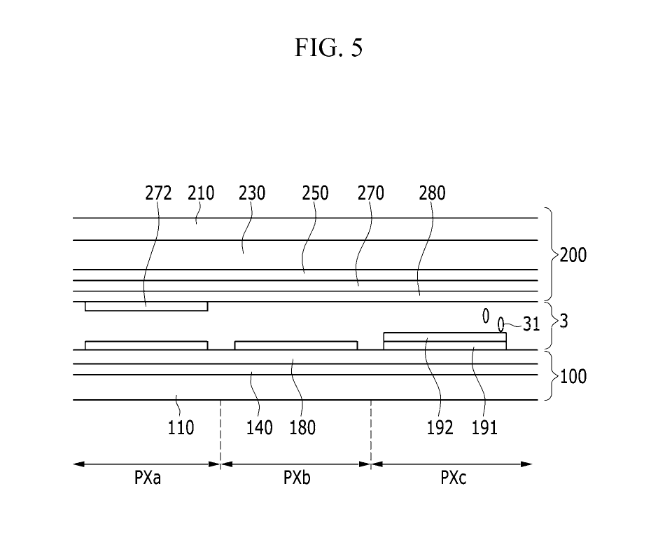

Referring to FIG. 5, according to another exemplary embodiment of the present invention, an insulating layer 280 may be disposed between the common electrode 270 and the piezoelectric element 272. When the insulating layer is disposed between the electrode which receives a voltage and the piezoelectric element, an intensity of an electric field which affects the piezoelectric element is changed, and therefore, in the degree of mechanical displacement of the piezoelectric element is changed. As a result, an electric field applied to a corresponding region may be changed.

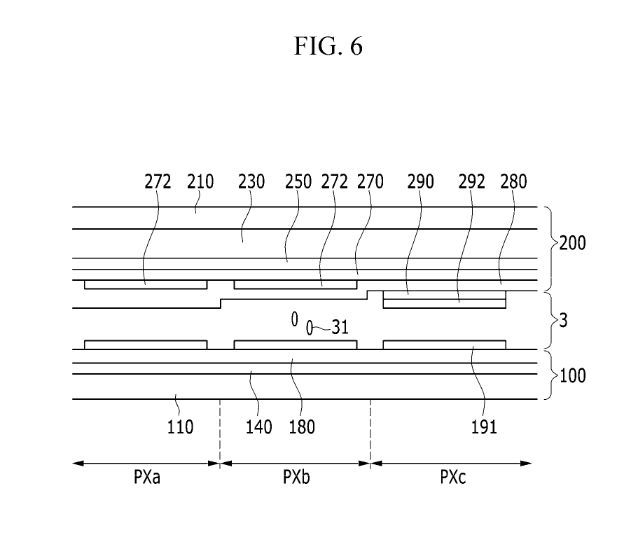

Referring to FIG. 6, according to another exemplary embodiment of the present invention, an insulating layer 280 may be disposed on the common electrode 270 and over one or more piezoelectric elements 272. In particular, the insulating layer 280 according to another exemplary embodiment of the present invention may have different thicknesses in respective regions.

The thickness of the insulating layer 280 may vary in any manner. For example, the thickness of the insulating layer 280 disposed in the first region PXa may be thicker than that of the insulating layer 280 disposed in the second region PXb. Therefore, even when the piezoelectric elements 272 are disposed on the common electrode 270 in both the first region PXa and the second region PXb, different electric fields may be formed in the first region PXa and the second region PXb depending on a difference in thickness of the insulating layer 280 disposed on the piezoelectric element 272.

Also, according to another exemplary embodiment of the present invention, a floating electrode 290 disposed on the insulating layer 280 may be further included. The floating electrode 290 is disposed on the insulating layer 280 and is not connected to other electrodes physically. The floating electrode 290 has a floating state with respect to the common electrode 270.

Referring to FIG. 6, a piezoelectric element 292 may be disposed on the floating electrode 290 according to another exemplary embodiment of the present invention.

According to another exemplary embodiment, in the first region PXa, an electric field which affects the liquid crystal layer 3 also passes through the piezoelectric element 272 and a relatively thick insulating layer 280. In the second region PXb, an electric field which affects the liquid crystal layer 3 also passes through the piezoelectric element 272 and a relatively thin insulating layer 280. Finally, in the third region PXc, an electric field which affects the liquid crystal layer 3 also passes through the floating electrode 290 disposed on the common electrode 270 and the piezoelectric element 292 disposed on the floating electrode 290.

According to another exemplary embodiment of the present invention, one pixel includes the pixel electrode 191 and the common electrode 270 across which a voltage is applied, and may include a plurality of regions in which different electric fields are formed according to presence or absence of a piezoelectric element, a thickness of an insulating layer, the presence or absence of a floating electrode 290, or the like. In this manner, several variables are introduced by which liquid crystal cell gap may be adjusted within individual pixel regions as desired.

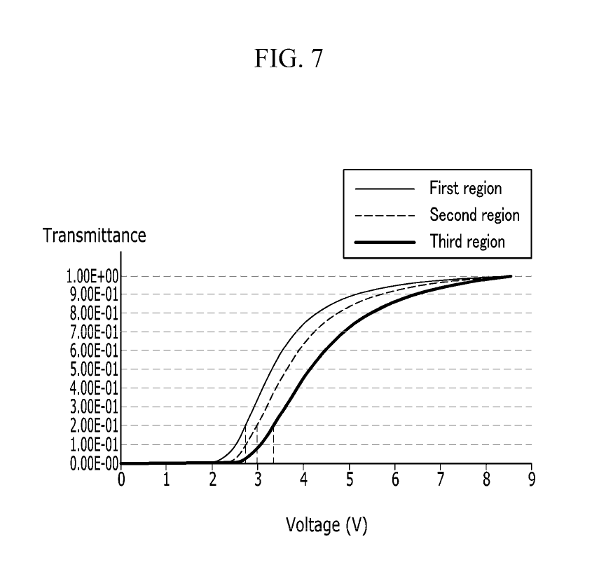

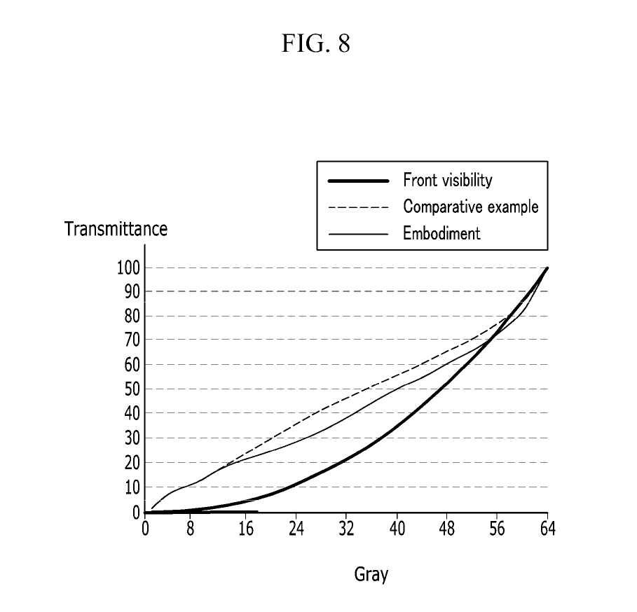

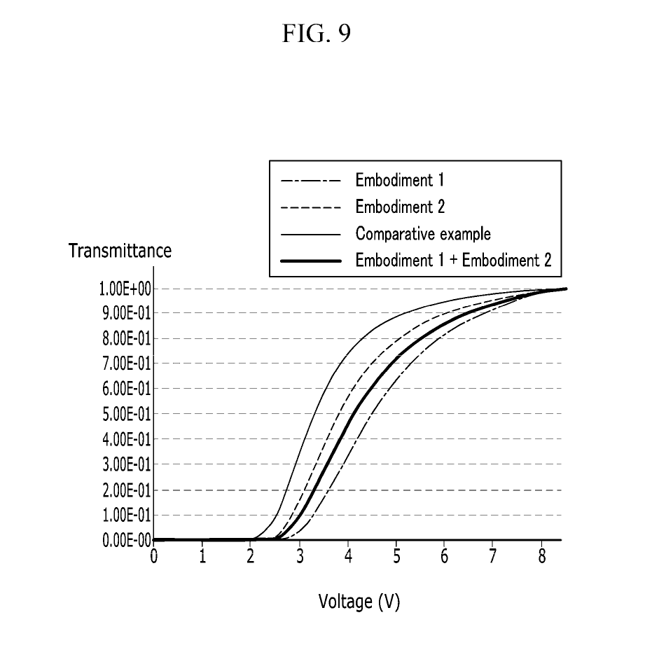

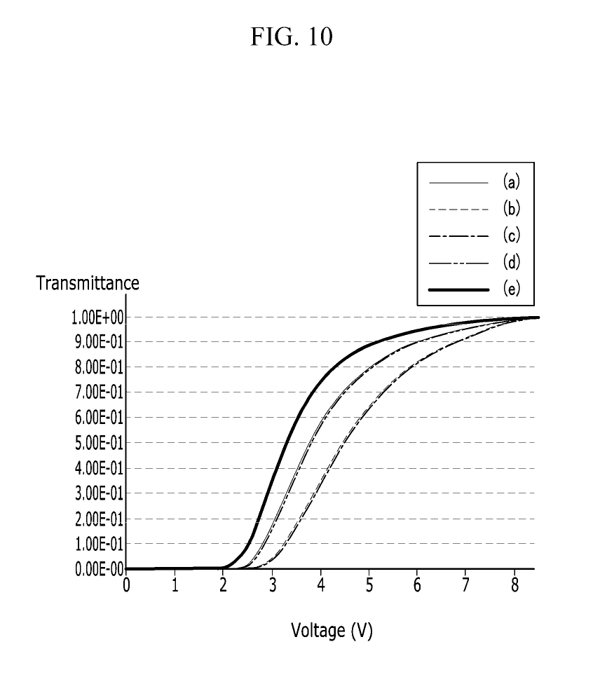

Hereinafter, effects of a liquid crystal display according to exemplary embodiments of the present invention will be described with reference to FIGS. 7 to 10. FIG. 7 is a V-T graph of one pixel constructed according to an exemplary embodiment of the present invention, FIG. 8 is a gamma graph of one pixel constructed according to an exemplary embodiment of the present invention, and FIGS. 9 and 10 are V-T graphs of a pixel driven by both a positive polarity and a negative polarity and constructed according to an exemplary embodiment.

First, referring to FIG. 7, a curved solid line located at the far-left of FIG. 7 corresponds to the first region PXa shown in FIG. 3, a curved dashed line located at the center of FIG. 7 corresponds to the second region PXb shown in FIG. 3, and a curved bolded line located at the far-right of FIG. 7 corresponds to the third region PXc shown in FIG. 3.

Specifically, the graph shown in FIG. 1 is a V-T graph for the respective regions having conditions as shown in Table 1.

TABLE 1

| | first region | second region | third region |
|---|---|---|---|
| cell gap (μm) | 3.4 | 3.2 | 2.8 |
| thickness (μm) of | — | 0.2 | 0.6 |
| piezoelectric element | | | |
| dielectric constant of | — | 6.5 | 6.5 |
| piezoelectric element | | | |

When the curved line corresponding to the first region is compared with the curved line corresponding to the second region, it can be seen that a V-T curved-line is shifted to the right depending on whether a piezoelectric element is present between the pixel electrode and the common electrode. In addition, when the curved line corresponding to the second region is compared with the curved line corresponding to the third region, it can be seen that the V-T curved-line is further shifted to the right with increased thickness of the piezoelectric element. This indicates that as a thickness of the piezoelectric element increases, the luminance decreases.

Although liquid crystal molecules are disposed throughout the same pixel, alignment of liquid crystal molecules disposed in a pixel region varies depending on whether a piezoelectric element is disposed in the region and according to a thickness of the piezoelectric element. Due to this, transmittance of various pixel regions can be changed.

According to exemplary embodiments of the present invention, one pixel including three regions which are different according to presence or absence of a piezoelectric element or a thickness of the piezoelectric element provides the same effect as one pixel including three regions to which different voltages are applied, thereby providing one pixel having an improved lateral visibility.

Referring to FIG. 8, a curved bolded line corresponding to a front visibility of the liquid crystal display device is located on the far-right, and a display device including a piezoelectric element according to an exemplary embodiment of the present invention corresponds to a curved solid but non-bolded line located at the center. In addition, a display device in which there is no piezoelectric element and whose pixels include one thin film transistor and one pixel electrode according to a comparative example corresponds to a curved dashed line located on the far-left.

Referring to FIG. 8, it can be seen that, when a piezoelectric element is included according to an exemplary embodiment of the present invention, lateral visibility is improved to be close to front visibility

As described above, the reason for this is that one pixel to which the same voltage is applied includes a plurality of regions having different liquid crystal alignment. That is, it can be seen that the liquid crystal display according to an exemplary embodiment has improved lateral visibility through one pixel having a plurality of regions of differing transmittance.

Referring to FIG. 9, exemplary embodiment 1 corresponds to a case in which a second region as described above has voltage of a positive polarity applied thereto, exemplary embodiment 2 corresponds to a case in which a second region as described above has voltage of a negative polarity applied thereto, and a comparative example corresponds to a case of a first region as described above, i.e. a region having no piezoelectric element.

As can be seen from FIG. 9, the curves of exemplary embodiments 1 and 2 are largely symmetric with respect to a line generated by averaging the curves of exemplary embodiments 1 and 2, and these curves are all are located on the right of the curve of the comparative example that has no piezoelectric element.

Referring to FIG. 10, there is a V-T graph in which curved line (a) represents a case in which the electrodes of the first region of FIG. 4 have a positive polarity voltage applied thereto, curved line (b) represents a case in which the electrodes of this first region have a negative polarity voltage applied thereto, curved line (c) represents a case in which the electrodes of the third region have a positive polarity voltage applied thereto, curved line (d) represents a case in which the electrodes of the third region have a negative polarity voltage applied thereto, and curved line (e) represents a case in which a piezoelectric element is not disposed as in the second region.

In this case, the curved line (a) and the curved line (d) coincide with each other, and the curved line (b) and the curved line (c) coincide with each other. This indicates that liquid crystal molecule alignment according to a positive polarity in the exemplary embodiment in which a piezoelectric element is disposed in an upper panel is similar to liquid crystal molecule alignment according to a negative polarity in the exemplary embodiment in which a piezoelectric element is disposed in a lower panel, and liquid crystal molecule alignment according to a negative polarity in the exemplary embodiment in which a piezoelectric element is disposed in the upper panel is similar to liquid crystal molecule alignment according to a positive polarity in the exemplary embodiment in which a piezoelectric element is disposed in the lower panel. Therefore, even in the case of inversion driving, it is possible to provide a uniform display quality.

As described above, one pixel according to exemplary embodiments of the present invention includes one thin film transistor and one pixel electrode. Even when the same voltage is applied through piezoelectric elements disposed in respective regions, it is possible to provide a plurality of regions having different luminances, thereby providing a display device having improved lateral visibility.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Furthermore, different features of the various embodiments, disclosed or otherwise understood, can be mixed and matched in any manner to produce further embodiments within the scope of the invention.

<Description of symbols>

| | |
|---|---|
| 3: Liquid crystal layer | 81, 82: Contact assistants |
| 100: Lower panel | 110: First insulation substrate |
| 121: Gate wire | 124: Gate electrode |
| 129: Gate pad | 140: Gate insulating layer |
| 154: Semiconductor layer | 165: Ohmic contact |
| 171: Data wire | 173: Source electrode |
| 175: Drain electrode | 179: Data pad |
| 180: Passivation layer | 185: Contact hole |
| 191: Pixel electrode | 200: Upper panel |
| 210: Second insulation substrate | 220: Light blocking member |
| 230: Color filter | 250: Overcoat |
| 270: Common electrode | |

What is claimed is:

1. A liquid crystal display comprising:
a first insulation substrate;
a thin film transistor disposed on the first insulation substrate;
a pixel electrode connected to the thin film transistor;
a second insulation substrate facing and spaced apart from the first insulation substrate;
a common electrode disposed on the second insulation substrate;
a liquid crystal layer disposed between the pixel electrode and the common electrode; and
one or more piezoelectric elements overlying one or more portions of at least one of the pixel electrode and the common electrode.

2. The liquid crystal display of claim 1, wherein:
the piezoelectric elements are transparent.

3. The liquid crystal display of claim 2, wherein:
the piezoelectric elements comprise any one or more of polydimethylsiloxane (PDMS), nanowire graphene, and polyvinylidene difluoride (PVDF).

4. The liquid crystal display of claim 1, wherein the pixel electrode comprises:
a plurality of plates; and
connection parts connecting adjacent plates.

5. The liquid crystal display of claim 4, wherein edges of the plates define a plurality of regions; and,
the piezoelectric elements of different ones of the regions are not connected to each other.

6. The liquid crystal display of claim 5, wherein:
the piezoelectric elements are disposed in one or more of the regions.

7. The liquid crystal display of claim 5, wherein:
the plurality of regions includes a first region, a second region, and a third region; and
the piezoelectric elements are disposed on the common electrode in the first region and are disposed on the pixel electrode in the third region.

8. The liquid crystal display of claim 5, wherein the piezoelectric elements disposed in different regions have differing thicknesses.

9. The liquid crystal display of claim 1, wherein the piezoelectric elements are disposed on the common electrode.

10. The liquid crystal display of claim 1, further comprising a floating electrode disposed on the common electrode.

11. The liquid crystal display of claim 10, wherein the piezoelectric elements are disposed on the floating electrode.

12. The liquid crystal display of claim 1, further comprising an insulating layer disposed under the piezoelectric elements, wherein the insulating layer has different thicknesses in different regions.
